(19) United States
(12) Patent Application Publication
(10) Pub. No.: US 2005/0281710 A1
(43) Pub. Date: Dec. 22, 2005

(54) Low thermal mass multiple tube capillary sampling array

(76) Inventor: James Hansen Crabtree, Long Beach, CA (US)

Correspondence Address: AGILENT TECHNOLOGIES, INC.;Legal Department, DL429, Intellectural Property Administration, P.O. Box 7599, Loveland, CO, 80537-0599, US

(21) Appl. No.: 10/872,865

(22) Filed: Jun. 21, 2004

(51) Int. Cl. B01L 3/02

(52) U.S. Cl. 422/100; 422/101

(57) ABSTRACT

A capillary sampling array comprises a closely packed array of capillaries having any interstitial spaces therebetween filled with a material physically and mechanically compatible with the material from which the capillaries are formed and an outer jacketing material covering the closely packed array of capillaries.

### BACKGROUND

Many trace monitoring applications use sampling tubes to collect and concentrate a representative sample. A sample may comprise a matrix such as air or stack gas or some other fluid containing traces of impurities. The objective of collecting a sample in this manner is to increase the mass of the hazardous compounds of interest so that they can be separated, detected and reported. This technique can be used to detect the presence of, for example, chemical warfare agents (CWAs), explosives, or toxic industrial compounds (TICs). Such compounds are often referred to as “target” compounds. Typically, the inside of the sampling tube is coated with or contains a material that is suitable for trapping the target compounds for which the matrix is being monitored.

In an instrumentation system that is used to monitor an industrial facility that may leak hazardous substances (e.g., a facility that is disassembling and disposing chemical weapons), a variety of instruments may be deployed throughout the plant and its environs. Where traces of toxic compounds in air, for example, may be present along with other compounds either from the plant or from the background air, the preferred instrument package is an air concentrator/desorber connected to a gas chromatograph. This type of instrument package is deployed throughout the facility in a variety of locations where workers may be present. These locations include areas of the plant where the toxic compounds are only occasionally present and then only at very low levels, areas where the toxic compounds are more frequently present and, if present, may be encountered at hazardous levels, and areas around the perimeter of the plant. Perimeter monitoring is normally done by collecting samples of air at various locations around the periphery of the facility. These samples are returned to the laboratory and analyzed to assure that emissions from the plant are below levels deemed to be hazardous to the general population as established by regulatory authorities. These air samples are analyzed using, for example, gas chromatography to detect the presence and amounts of hazardous substances. In many of these situations, the ability to rapidly collect the air sample, and rapidly analyze it is extremely important. In order to protect the workers from undue exposure the regulatory authority may require that the total sampling, analysis and reporting time be less than or equal to a predetermined time (e.g., 10 minutes). An instrument package of this type is referred to as a Near-Real-Time or NRT analyzer.

To collect the substances in the air sample, an air sampling tube is typically packed with a porous polymer column packing material referred to as “TENAX,” a trademark of Tenax Fibers, GMBH & Co., comprising polybiphenylene oxide. The TENAX is typically loaded into the tube in the form of a particle bed along with a secondary bed of a material such as HayeSep® Q to backup the TENAX and prevent breakthrough of the compounds of interest. HayeSEP® is a registered trademark of Hayes Separations, Inc. After the air sample is collected by the air sampling tube, the sample is desorbed to release the collected substances trapped in the air sampling tube. The desorption process may require multiple steps to liberate the collected substances from the TENAX particle bed. For example, the sample can be first desorbed onto what is referred to as a “focusing trap” to liberate and further concentrate any target compounds from the inside of the air sampling tube. The focusing trap may also contains TENAX. In this case the collected volatile compounds are transferred to the focusing trap by rapidly heating the sample tube to approximately 250° C. Then, the sample must be transferred from the focusing trap to a chromatographic column. This is performed by reversing the direction of trap flow and again heating the trapped compounds in the focusing trap to liberate them from the TENAX, while holding the chromatographic oven at a constant initial temperature that is low enough to focus the target compounds in a narrow band on the column. Unfortunately, this process requires at least two heating and cooling cycles, is time consuming, and often results in some of the collected substance remaining in the TENAX. Furthermore, TENAX is subject to degradation by reaction with water and polymerizable background compounds in the sample. This necessitates a dewatering step in which dry nitrogen or other such gas flows through the sample bed for a prescribed period of time. This multiple step process can adversely lengthen the time interval during which the workers may be inadvertently exposed to the presence of hazardous target compounds in the plant air without anyone being aware of it. Losses can also occur in the adsorption/desorption process for a variety of reasons, including possibly the reaction of the target compounds with water vapor or the adsorption of the target compounds onto active sites within the sampling system, which results in a reduction of the amount of collected substance entering the chromatograph. This in turn leads to low readings or in the worst case false negative results.

Therefore, it would be desirable to transfer the collected volatile substances directly to a chromatographic column in one step, and to rapidly perform a sample/desorption cycle.

### SUMMARY OF INVENTION

According to one embodiment, a sample trap comprises a closely packed array of capillaries having any interstitial spaces therebetween filled with a material physically and mechanically compatible with the material from which the capillaries are formed and an outer jacket of the same material covering the closely packed array of capillaries so that the tube array can be installed and pressurized inside a thermal desorption device.

Other aspects and advantages of the invention will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures in which:

FIG. 1 is a schematic view illustrating a capillary tube constructed in accordance with an embodiment of the invention.

FIG. 2A is a schematic diagram illustrating a cross section of a partially complete capillary array constructed in accordance with an embodiment of the invention.

FIG. 2B is a schematic diagram illustrating a cross section of a complete capillary array constructed in accordance with an embodiment of the invention.

FIGS. 3A and 3B collectively illustrate a representative embodiment of a capillary array trap constructed in accordance with an embodiment of the invention.

FIG. 4 is a schematic diagram illustrating the junction between a plurality of capillary tubes and the inside of the cladding of FIG. 2B.

FIGS. 5A and 5B are a schematic diagram collectively illustrating portions of a six-port thermal desorption sampler (TDS) in both a sample (FIG. 5A) and a desorption (FIG. 5B) mode.

FIGS. 6A and 6B are a schematic diagram collectively illustrating an alternative embodiment of the thermal desorption sampler of FIGS. 5A and 5B.

FIGS. 7A and 7B are a schematic diagram collectively illustrating another embodiment of the thermal desorption sampler of FIGS. 5A and 5B.

FIGS. 8A and 8B are a schematic diagram collectively illustrating another embodiment of the thermal desorption sampler of FIGS. 7A and 7B.

### DETAILED DESCRIPTION

While described below for use in collecting air samples, the low thermal mass multiple tube capillary sampling array, referred to hereafter as the “capillary array trap,” can be used to sample any fluid matrix, and to rapidly and efficiently release collected substances. In one example, the detection of trace amounts, on the order of 100 nanograms/meter³, of what is referred to as “mustard gas” is desired. It is desired to measure and report the presence of mustard gas in a five minute cycle, which includes sampling and analyzing the sample. Further, the capillary array trap can be used to sample liquid materials for desorption onto a liquid chromatograph.

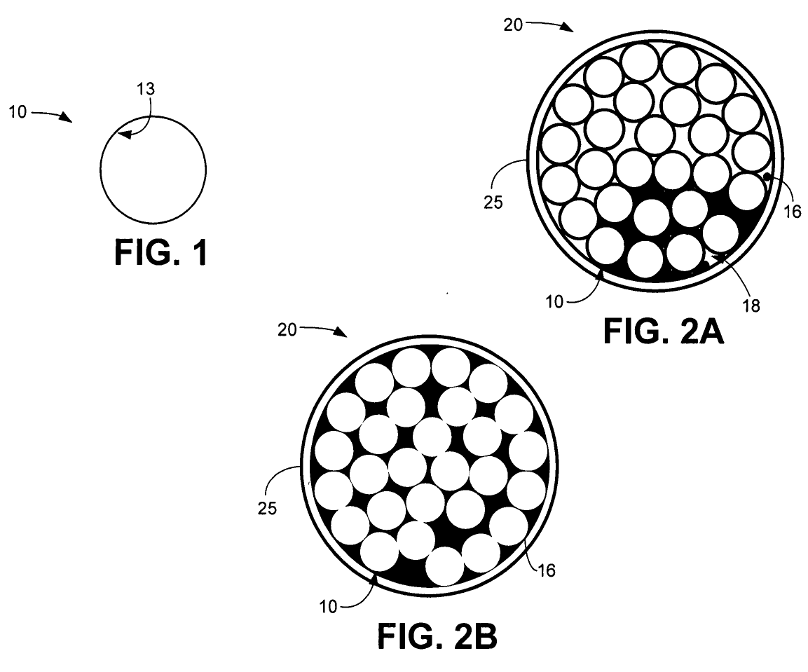

FIG. 1 is a schematic view illustrating a capillary tube 10 used to construct the capillary array trap of the invention. The capillary tube 10 is preferably fabricated from a glass material, such as, for example, borosilicate or Pyrex®. Each capillary tube 10 can have an outer diameter (OD) and wall thickness depending on the application. For example, each capillary tube 10 could have a diameter ranging between 100 and 250 micrometers (also referred to as “micron,” or μm). Each capillary tube 10 could have, for example, a five micron wall thickness. The individual tubes include an inner surface 13 coated with a passivation agent to prevent interactions between the sample and the tube walls as well as a material suitable for collecting sample substances. The material coating the inner surface 13 of each capillary tube 10 is referred to as a “trapping phase.” The trapping phase can have various compositions and thicknesses depending on the application. Further, the trapping phase can be a solid or a liquid. The passivation agent is typically a liquid. The thickness of the trapping phase applied to the inner surface 13 of each tube 10 depends on the material used as the trapping phase, and is generally applied as a thin film, approximately 1-10 microns thick. Other thicknesses, depending on the material used, are also possible. Solid phases can also be coated on the inside walls of the individual tubes for the purposes of trapping target compounds in the sample.

Depending on the type of substance sought to be trapped in the capillary tube 10, the trapping phase might be a polar material such as a polyethylene glycol, or might be a non-polar material such as dimethylpolysiloxane or an intermediate polarity phase such a 50% tricyanomethyl dimethylpolysiloxane. Essentially, the smaller the inner diameter of the tube, the higher the linear velocity of air through the array. Accordingly, whether a laminar flow or a turbulent flow occurs through the capillary tube 10 will affect the ability of the trapping phase inside the capillary tube 10 to capture the samples of material that are sought to be detected.

The dimensions of the capillary tube 10 provided above are for exemplary purposes only. The length, wall thickness, inner diameter, outer diameter, material, and other parameters of the capillary tube 10 are arbitrary and variable.

FIG. 2A is a schematic diagram illustrating a cross section of a partially complete capillary array constructed in accordance with an embodiment of the invention using the capillary tubes 10 of FIG. 1. The capillary array 20 comprises a plurality of capillary tubes 10 packed in close proximity to each other surrounded by a cladding 25. The cladding 25 can also be fabricated of a glass material of various thicknesses such as, for example, borosilicate glass or Pyrex®, and preferably has a wall thickness of approximately 250-500 microns. The interstitial spaces, an exemplary one of which is illustrated using reference numeral 18, between the inner wall of the cladding 25 and the capillary tubes 10, or between the capillary tubes 10, is filled with a filler material 16 that is physically and mechanically compatible with the material from which the capillary tubes 10 are formed. For example, the filler material 16 can be, for example, glass rods 16 or another glass material that fuses and melts to the outside of the capillary tubes 10 when the capillary tubes 10 are formed into a capillary array 20. The interstitial spaces 18 between the capillary tubes 10 are filled with a glass material 16 so as to eliminate the interstitial spaces 18 from the finished capillary array 20. The capillary array 20 in FIG. 2A is shown partially complete so that the filling of the interstitial spaces 18 between the capillary tubes 10 can be shown.

The structure of the capillary array 20, and each capillary tube 10 (FIG. 1), results in only the circular cross sections of the capillary tubes 10 (FIG. 1) being exposed to the sample matrix flowing through the capillary array 20. The dense packing of the capillary tubes 10 and the thin film trapping phase material applied to the inner surface 13 of each capillary tube 10 allows the capillary array 20 to trap and release collected substances in a single sample/desorption step. While show in FIG. 2A using 27 capillary tubes 10, the number of capillary tubes 10 is arbitrary and, in one embodiment, a capillary array 20 would likely include approximately 200-500 individual capillary tubes 10. However, a capillary array 20 may include from ten (10) to over 1000 individual capillary tubes 10. The number of individual capillary tubes 10 is dependent upon, among other factors, the packing fraction obtainable based on the outer diameter of the capillary tubes 10 and the inner diameter of the cladding 25. A packing fraction of at least 80% is reasonable.

FIG. 2B is a schematic diagram illustrating a cross section of a complete capillary array constructed in accordance with an embodiment of the invention. All the interstitial spaces 18 between the inner wall of the cladding 25 and the capillary tubes 10, and between the individual capillary tubes 10, are filled with a filler material 16. In this manner, only the circular cross sections of the capillary tubes 10 are exposed to fluid flowing through the capillary array 20.

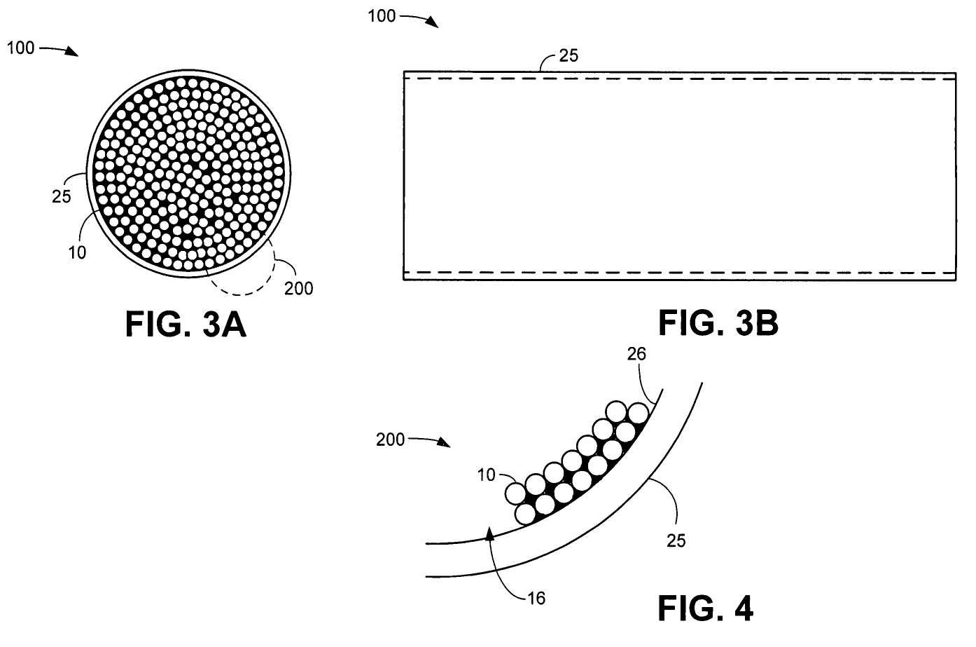

FIGS. 3A and 3B collectively illustrate a representative embodiment of a capillary sampling array, sometimes referred to as a “capillary array trap” a “sample trap” or a “sample array” constructed in accordance with an embodiment of the invention. In one embodiment, the capillary sampling array 100 comprises a plurality of capillary tubes 10 densely packed into a capillary array 20 as shown in FIG. 2B, and then formed into an approximate 6 mm, or 0.25 inch diameter capillary array trap 100. The forming process is typically referred to as “drawing” in which the capillary array 20 begins at a diameter larger than the desired finished diameter, and is drawn, or extruded, possibly also heated, and reduced in diameter to the desired diameter. The drawing process melts the filler material 16, thereby filling any interstitial spaces 18 between the capillary tubes 10 and between the capillary tubes 10 and the inner surface of the cladding 25.

A preferred length of the capillary sampling array 100 in this example is approximately 4.5 inches and can be, for example, 6 mm or 0.25 inch in diameter, depending upon application. However, the overall length and diameter of the capillary sampling array 100 is arbitrary and variable, depending on application. A capillary sampling array 100 may range from approximately 0.125 inch in diameter to over 0.5 inch in diameter, and the overall length of the capillary sampling array 100 may range from approximately 1 inch to three or four feet or more.

The process of drawing the capillary array 20 down in diameter to form the capillary sampling array 100, causes the filler material 16 in the interstitial spaces 18 between each capillary tube 10, and the spaces 18 between each capillary tube 10 and the inside of the cladding 25, to melt and form a single solid material surrounding each capillary tube 10. In this manner, all fluid passing through the capillary sampling array 100 will travel through a structure having a circular cross section, i.e., each capillary tube 10 (FIG. 1).

FIG. 4 is a schematic diagram 200 illustrating the area between a plurality of capillary tubes 10 and the inside of the cladding 25 of FIGS. 2A and 2B. As shown in FIG. 4, the filler material 16 fills all the spaces between the capillary tubes 10 and an interior surface 26 of the cladding 25.

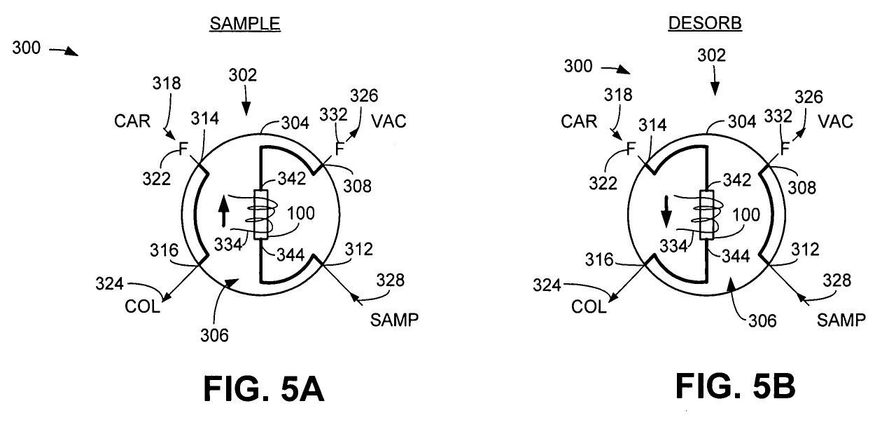

FIGS. 5A and 5B are a schematic diagram collectively illustrating portions of a six-port thermal desorption sampler (TDS) 300 in both a sample (FIG. 5A) and a desorption (FIG. 5B) mode. The thermal desorption sampler 300 includes a valve 302 having a valve body 304 and rotor 306. The thermal desorption sampler 300 shown in FIGS. 5A and 5B is referred to as a “six-port” thermal desorption sampler with the six ports being a vacuum port 308, a sample port 312, a carrier gas port 314, a column port 316, a first port 342 of the capillary array trap 100 and a second port 344 of the capillary sampling array 100. The temperature of the capillary sampling array 100 is controlled using a heater 334. The vacuum port 308 is coupled to a vacuum source 326 through a flow controller 332. A carrier gas source 318 is coupled through a flow controller 322 to the carrier gas port 314.

As illustrated in FIG. 5A, during the sampling phase of the thermal desorption process, a vacuum 326 is applied via port 308 through a flow controller 332 to draw a sample 328 through the sample port 312 and through the port 344 into the capillary array trap 100 in the direction shown. For example, a vacuum of approximately 450 torr (approximately 0.7 atmosphere) is applied via the vacuum port 326 to fill the capillary array trap 100 with a sample fluid, in this example air.

After the valve 302 is operated to fill the capillary sampling array 100 with a sample, it then switches to a desorption mode of operation. In FIG. 5B, the desorption mode of operation is illustrated whereby the first port 342 of the capillary sampling array 100 is coupled to the carrier gas source 318 via the port 314 through the flow controller 322. During the desorption process, the capillary sampling array 100 is rapidly heated from approximately 40° C. to approximately 300° C. by the heater 334. As the carrier gas flows through the capillary sampling array 100, any substance collected on the interior walls of each capillary tube 12 (FIG. 1) by the trapping phase is quickly and in a single step released to flow through the port 316 into an analysis column 324. The analysis column 324 can be, for example, the analysis column of a gas chromatograph.

In this manner, the capillary sampling array 100 is used to collect samples and quickly release the collected material through a single step sample and desorption process. The thermal desorption process rapidly heats the capillary sampling array 100 (from approximately 40° C. to approximately 300° C. in approximately 20 seconds) to bake off the collected substance contained within the trapping phase on the inside of each capillary tube 10. As illustrated, the carrier gas is supplied via the carrier gas source 318 in a direction opposite from the direction of flow during the sampling mode of operation.

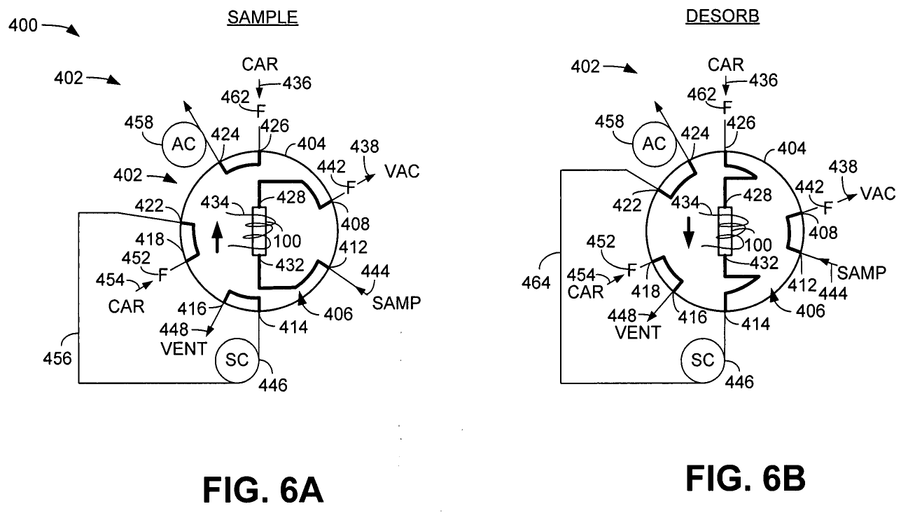

FIGS. 6A and 6B are a schematic diagram collectively illustrating an alternative embodiment of the thermal desorption sampler of FIGS. 5A and 5B. The thermal desorption sampler 400 includes a valve 402 having a valve body 404 and a rotor 406. The thermal desorption sampler in FIGS. 6A and 6B is referred to as a “ten-port” thermal desorption sampler. The thermal desorption sampler 400 includes a vacuum port 408, a sampling port 412, an input port 414 for a stripper column 446, a vent port 416, a carrier gas input port 418, an output port 422, another output port 424 coupled to an analysis column 458, and the first port 428 and second port 432 of the capillary array trap 100.

During the sampling phase, a vacuum source 438 is coupled through a flow controller 442 to the vacuum port 408. The vacuum source 438 draws sample air 444 in through the sample port 412, via the port 432 and into the capillary sampling array 100 in the direction shown.

Simultaneously, carrier gas is supplied from a carrier gas source 436 through a flow controller 462 through the port 426 and out of the port 424 into the analysis column 458 of a gas chromatograph (not shown). Further, a carrier gas source 454 supplies carrier gas through a flow controller 452 through a carrier gas port 418 and out of the valve 402 via the port 422. The port 422 is coupled to a conduit 456 and to a stripper column 446, and then through the port 414 through the valve 402 and out of the port 416 through the vent 448. The stripper column 446 removes undesirable high boiling point material that otherwise would have flowed to the analysis column 458 after the target compounds have eluted.

In the six-port thermal desorption sampler 300 all material in the capillary sampling array 100 flows to the gas chromatograph column. This includes many contaminants, such as, for example, vehicle exhaust including materials that range from butane to naphthalene, and organic materials such as terpenes from pine trees, etc. Essentially, these are materials that make detection of the desired materials difficult. Therefore, a stripper column 446 is implemented to remove (i.e., strip) the undesirable high boiling point materials after the desired target compounds have been desorbed and transferred to the analysis column 458.

FIG. 6B is a schematic diagram illustrating the thermal desorption sampler 400 in a desorption mode. The port 408 is coupled through the flow controller 442 to a vacuum source 438 which draws a sample 444 through the port 412. This maintains a constant flow of sample through the thermal desorption sampler 400. However, the rotor 406 is rotated such that the port 428 of the capillary array trap 100 is now coupled to port 426 and to a carrier gas supplied through the flow controller 462 from the carrier gas source 436. The capillary sampling array 100 is rapidly heated, as described above, so that the carrier gas flowing through the capillary sampling array 100 causes any collected substances on the inside walls of the capillary tubes 10 to be desorbed and to flow through the port 414 into the stripper column 446. The stripper column 446 passes the low boiler target compounds and allows the collected substance to flow through the conduit 464 to the port 422 through the valve 402 and then through the port 424 into the analysis column 458. It should be mentioned that the analysis column 458 and the stripper column 446 could be portions of the same column, or can be separate columns.

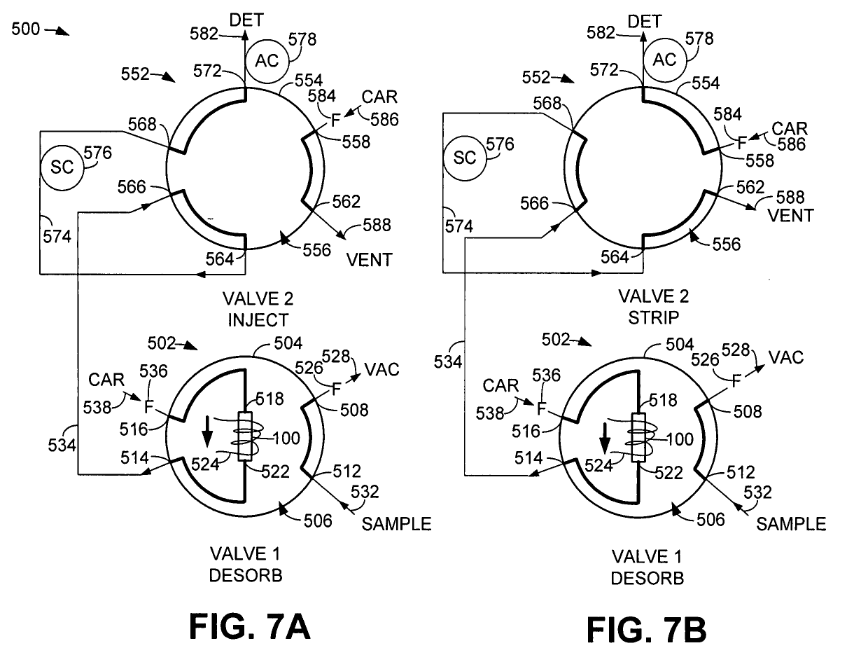

FIGS. 7A and 7B are a schematic diagram collectively illustrating another embodiment of the thermal desorption sampler of FIGS. 5A and 5B. The thermal desorption sampler 500 includes a first valve 502 and a second valve 552. The first valve 502 operates as a “sample/desorption” valve, as described above, while the second valve 552 directs the output of the capillary sampling array 100 to a stripper column 576 to remove the high boiling point materials from the sample after the desorption operation.

The first valve 502 include a valve body 504 and a rotor 506. Both of the valves 502 and 552 in the thermal desorption sampler 500 are “six-port” valves, as described above. The first valve 502 includes a vacuum port 508, a sample port 512, a port 514, a carrier gas port 516, and a first port 518 and a second port 522 of the capillary array trap 100.

During the desorption operation, the first valve 502 is operated to apply a vacuum source 528 to the vacuum port 508 via a flow controller 526. The vacuum 528 draws in a sample 532 via the sample port 512. A carrier gas 538 is supplied via the flow controller 536 through the port 516, and through the first port 518 and then through the capillary array trap 100. The capillary sampling array 100 is heated by the heater 524 as described above to release collected substances from the trapping phase in the capillary sampling array 100. The carrier gas carries away any released substances trapped and released by the trapping phase through the ports 522 and 514 into the conduit 534. The conduit 534 connects the port 514 of the first valve 502 to the port 566 of the second valve 552.

The second valve 552, also referred to as the “stripper valve,” includes a valve body 554, and a rotor 556. The second valve 552 also includes a carrier gas port 558, a vent port 562, a port 564, a port 566, a port 568, and a port 572. A carrier gas 586 is supplied through the flow controller 584 into the port 558, through the valve 552 and then out of the port 562 to the vent 588. This occurs during the “inject” mode of operation.

The sample substance transferred from the first valve 502 via conduit 534 passes through the port 566, through the valve 552 out of the port 564 and via conduit 574 to the stripper column 576. The stripper column 576 passes low boiling point materials from the collected substance that was just desorbed from the capillary sampling array 100.

The output of the stripper column 576 goes through port 568, through the valve 552 out of the port 572 and into the analysis column 578, and then to the detector 582. The detector 582 may be, for example, a gas chromatograph. By “stripping” off high-boiling, late-eluting material from the sample using the stripper column 576, baseline noise and offset at the detector can be minimized.

After the inject mode, the second valve 552 is placed in a “strip” mode, whereby the contents of the stripper column 576 are vented via the ports 564 and 562 through the vent 588. During the strip mode, a carrier gas 586 is supplied through the flow controller 584 into the port 558, and then out of the port 572, through the analysis column 578 and into the detector 582. The second valve 552 (stripper valve) operates independently of the first valve 502. The second valve 552 is placed in the inject position (FIG. 7A) just prior to performing a desorb operation on the contents of the capillary sampling array 100. After the components of interest have come off the stripper column 576 onto the analysis column 578, the second valve 552 is rotated to the strip position as shown in FIG. 7B so that the unwanted heavy components in the stripper column 576 can be vented.

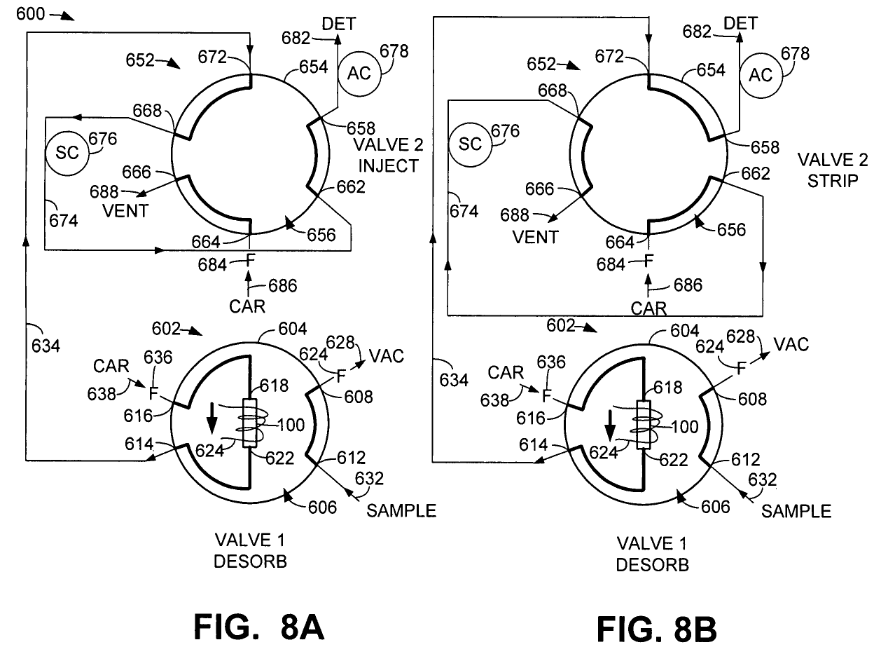

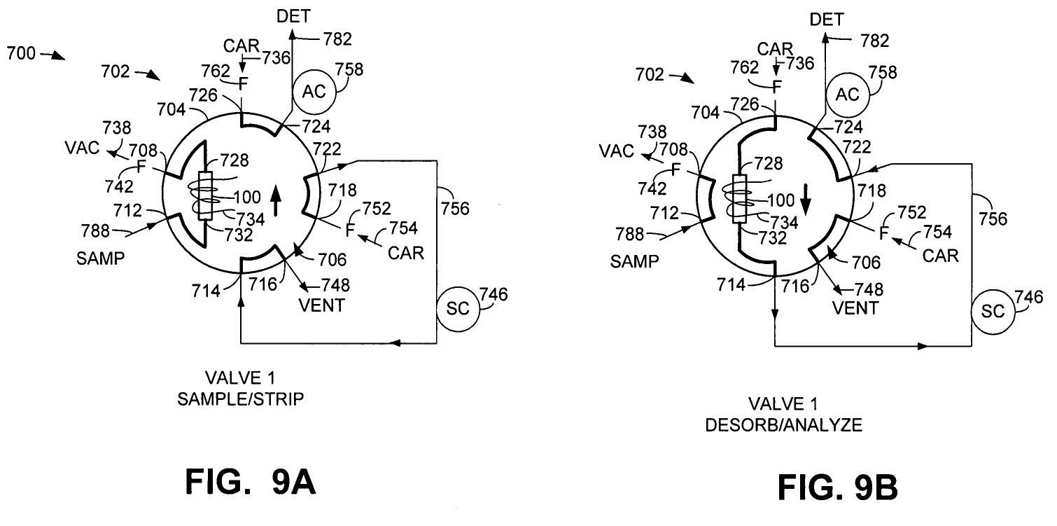

FIGS. 8A and 8B are a schematic diagram collectively illustrating another embodiment of the thermal desorption sampler of FIGS. 7A and 7B. The thermal desorption sampler 600 includes a first valve 602 and a second valve 652. The first valve 602 operates as a “sample/desorption” valve, as described above, while the second valve 652 directs the output of the capillary sampling array 100 to a stripper column 676 to remove the low boiling point materials from the sample prior to the desorption operation.

The first valve 602 includes a valve body 604 and a rotor 606. Both of the valves 602 and 652 in the thermal desorption sampler 600 are “six-port” valves, as described above. The first valve 602 includes a vacuum port 608, a sample port 612, a port 614, a carrier gas port 616, and a first port 618 and a second port 622 of the capillary array trap 100.

During the desorption operation, the first valve 602 is operated to apply a vacuum source 628 to the vacuum port 608 via a flow controller 624. The vacuum 628 draws in a sample 632 via the sample port 612. A carrier gas 638 is supplied via the flow controller 636 through the port 616, and through the first port 618 and then through the capillary sampling array 100. The capillary sampling array 100 is heated by the heater 624 as described above to release collected substances from the trapping phase in the capillary sampling array 100. The carrier gas carries away any released substances trapped and released by the trapping phase through the ports 622 and 614 into the conduit 634. The conduit 634 connects the port 614 of the first valve 602 to the port 672 of the second valve 652.

The second valve 652, also referred to as the “stripper valve,” includes a valve body 654, and a rotor 656. The second valve 652 also includes a carrier gas port 664, a vent port 666, a port 668, a port 672, a port 662, and a port 658. A carrier gas 686 is supplied through the flow controller 684 into the port 664, through the valve 652 and then out of the port 666 to the vent 688. This occurs during the “inject” mode of operation.

The sample substance transferred from the first valve 602 via conduit 634 passes through the port 672, through the valve 652 out of the port 668 to the stripper column 676. The stripper column 676 removes any high boiling point materials from the collected substance that was just desorbed from the capillary sampling array 100.

The output of the stripper column 676 goes via conduit 674 through port 662, through the valve 652 out of the port 658 and into the analysis column 678, and then to the detector 682. The detector 682 may be, for example, a gas chromatograph detector. By placing the stripper valve 652 in a “strip” mode after the target compounds have passed through the stripper column 676, heavier, late-eluting compounds can be removed from the head of the stripper column 676 preventing them from carrying over onto the analysis column 678 where they can create noise or increased offset on the detector baseline.

After the inject mode, the second valve 652 is placed in a “strip” mode, whereby the contents of the stripper column 676 are vented via the ports 668 and 666 through the vent 688. During the strip mode, a carrier gas 686 is supplied through the flow controller 684 into the port 664, and then out of the port 662, through the stripper column 676 and through the port 668, the valve 652 and through the port 666 to the vent 688. The output of the port 614 of the first valve 602 is transferred to the conduit 634 and is supplied to the port 672 of the second valve 652. The contents of the capillary sampling array are then communicated through the second valve 652 through the port 658 and into the analysis column 678. The second valve 652 (stripper valve) operates independently of the first valve 602. The second valve 652 is placed in the inject position (FIG. 8A) just prior to performing a desorb operation on the contents of the capillary sampling array 100. After the components of interest have come off the stripper column 676 the valve is placed in the position shown in FIG. 8B so that the contents of the capillary sampling array 100 can be transferred to the analysis column 678, while the unwanted heavy components of the stripper column 676 can be vented.

FIGS. 9A and 9B are a schematic diagram collectively illustrating an alternative embodiment of the thermal desorption sampler of FIGS. 6A and 6B. The thermal desorption sampler 700 includes a valve 702 having a valve body 704 and a rotor 706. The thermal desorption sampler in FIGS. 9A and 9B is referred to as a “ten-port” thermal desorption sampler. The thermal desorption sampler 700 includes a vacuum port 708, a sampling port 712, an input port 714 for a stripper column 746, a vent port 716, a carrier gas input port 718, an output port 722, another output port 724 coupled to an analysis column 758, and the first port 728 and second port 732 of the capillary array trap 100.

During the sampling phase, a vacuum source 738 is coupled through a flow controller 742 to the vacuum port 708. The vacuum source 738 draws sample air 788 in through the sample port 712, via the port 732 and into the capillary sampling array 100 in the direction shown.

Simultaneously, carrier gas is supplied from a carrier gas source 736 through a flow controller 762 through the port 726 and out of the port 724 into the analysis column 758 of a gas chromatograph (not shown). Further, a carrier gas source 754 supplies carrier gas through a flow controller 752 through a carrier gas port 718 and out of the valve 702 via the port 722. The port 722 is coupled to a conduit 756 and to a stripper column 746, and then through the port 714 through the valve 702 and out of the port 716 through the vent 748. The stripper column 746 removes undesirable high boiling point material that may otherwise flow to the analysis column 758.

FIG. 9B is a schematic diagram illustrating the thermal desorption sampler 700 in a desorption/analyze mode. The port 708 is coupled through the flow controller 742 to a vacuum source 738, which draws a sample 788 through the port 712. However, the rotor 706 is rotated such that the port 728 of the capillary array trap 100 is now coupled to port 726 and to a carrier gas supplied through the flow controller 762 from the carrier gas source 736. The capillary sampling array 100 is rapidly heated, as described above, so that the carrier gas flowing through the capillary sampling array 100 causes any collected substances on the inside walls of the capillary tubes 10 to be desorbed and to flow through the port 714 into the stripper column 746. The stripper column 746 retains the high boiling point material while allowing the target compounds to flow through the conduit 756 to the port 722 through the valve 702 and then through the port 724 into the analysis column 758. It should be mentioned that the analysis column 758 and the stripper column 746 could be portions of the same column, or can be separate columns.

The foregoing detailed description has been given for understanding exemplary implementations of the invention in the gas phase only and no unnecessary limitations should be understood therefrom as modifications will be obvious to those skilled in the art without departing from the scope of the appended claims and their equivalents. Other valves can be added to the system for the purpose of isolating certain target compounds for later analysis or for transferring target compounds onto a separate column where they can be separated from the potentially-interfering background matrix on the sample itself. The capillary array trap can also be used to trap target compounds in a liquid matrix by flowing liquid through it for a period of time. A liquid of different polarity can be used to remove the trapped compounds from the trap and transfer them to the head of a liquid chromatography column for the purpose of separating and quantization. Any of the valve arrangements described above can be used to automate this process. The trap can also be desorbed manually by connecting it to the inlet of the chromatograph regardless of the phase used.

1. A capillary sampling array, comprising:
a closely packed array of capillaries having any interstitial spaces therebetween filled with a material physically and mechanically compatible with the material from which the capillaries are formed; and
an outer jacketing material covering the closely packed array of capillaries.

2. The capillary sampling array of claim 1, wherein each capillary in the closely packed array of capillaries comprises a glass tube having a thin liquid film passivation and liquid coating of material suitable for trapping a desired substance.

3. The capillary sampling array of claim 1, wherein each capillary in the closely packed array of capillaries comprises a glass tube having a thin layer of solid material suitable for trapping a desired substance.

4. The capillary sampling array of claim 2, wherein each capillary tube is less than 250 microns in inside diameter.

5. The capillary sampling array of claim 2, wherein the closely packed array of capillaries further comprises at least 200 capillaries.

6. The capillary sampling array of claim 2, wherein the closely packed array of capillaries and the outer jacket are 6 mm in diameter.

7. The capillary sampling array of claim 2, wherein the closely packed array of capillaries and the outer jacket are at least ⅛ inch in diameter.

8. A thermal sampling and desorption system, comprising:
a capillary sampling array comprising a closely packed array of capillaries having any interstitial spaces therebetween filled with a material physically and mechanically compatible with the material from which the capillaries are formed and an outer jacketing material covering the closely packed array of capillaries;
a valve having a first position configured to locate the capillary sampling array to collect a sample and a second position configured to locate the capillary sampling array to transfer a collected sample to a chromatographic column; and
wherein the capillary sampling array releases the sample in a single step.

9. The thermal sampling and desorption system of claim 8, further comprising:
a stripper column configured to remove high boiling point material from the desorbed sample after the target compounds have eluted.

10. The thermal sampling and desorption system of claim 8, further comprising:
a second valve; and
a stripper column configured to remove high boiling point material from the desorbed sample after the target compounds have eluted.

11. The thermal sampling and desorption system of claim 10, wherein each capillary in the closely packed array of capillaries comprises a glass tube having a thin film coating of material suitable for trapping a desired substance.

12. The thermal sampling and desorption system of claim 11, wherein the thin film coating is liquid.

13. The thermal sampling and desorption system of claim 11, wherein the thin film coating is solid.

14. The thermal sampling and desorption system of claim 10, wherein each capillary tube is less than 250 microns in inside diameter.

15. The thermal sampling and desorption system of claim 10, wherein the closely packed array of capillaries further comprises at least 200 capillary tubes.

16. The thermal sampling and desorption system of claim 10, wherein the closely packed array of capillaries and the outer jacket are 6 mm in diameter.

17. The thermal sampling and desorption system of claim 10, wherein the closely packed array of capillaries and the outer jacket are at least ⅛ inch in diameter.

18. A method for performing sample collection and desorption, comprising:
collecting a sample using a capillary sampling array comprising a closely packed array of capillaries having any interstitial spaces therebetween filled with a material physically and mechanically compatible with the material from which the capillaries are formed and an outer jacketing material covering the closely packed array of capillaries;
heating the capillary sampling array so that material collected by the capillary sampling array is released in a single step;
transferring the released sample to an analysis device.

19. The method of claim 18, wherein the capillaries in the capillary sampling array include a thin film coating of trapping phase.
